(19) United States
(12) Patent Application Publication
(10) Pub. No.: US 2011/0221707 A1
(43) Pub. Date: Sep. 15, 2011

(54) DISPLAY DEVICE HAVING OPTICAL SENSOR

(75) Inventors: Kei Oyobe, Osaka (JP); Masahiro Adachi, Osaka (JP)

(73) Assignee: SHARP KABUSHIKI KAISHA, Osaka (JP)

(21) Appl. No.: 13/129,103

(22) PCT Filed: Jun. 25, 2009
(86) PCT No.: PCT/JP2009/061597

§ 371 Date: May 16, 2011

(30) Foreign Application Priority Data
Nov. 14, 2008 (JP) 2008-292149

(51) Int. Cl. G06F 3/042

(52) U.S. Cl. 345/175

(57) ABSTRACT

A plurality of pixel circuits are provided on a TFT-side substrate 11, light blocking layers 15 and light blocking layer openings 16 are provided between the pixel circuits, and optical sensors 17 are arranged at positions where the light blocking layers 15 are provided. Light blocking layers 18 are also provided at opposing portions of the opposite substrate 12, and light reflecting units 19 are provided correspondingly to the optical sensors 17. In the normal state, backlight BL that has passed through the TFT-side substrate 11 is reflected by the light reflecting unit 19 and falls on the optical sensor 17. When the front surface of the liquid crystal panel is pressed, the two substrates come close to each other, the light reflection direction in the light reflecting unit 19 changes, and the intensity of light detected by the optical sensor 17 changes. By subjecting the obtained sensor image to an image recognition process, it is possible to eliminate the effect of the external light and detect the touch position on the display screen with high accuracy.

### TECHNICAL FIELD

The present invention relates to a display device, and more particularly, to a display device in which a plurality of optical sensors are provided on a display panel.

### BACKGROUND ART

Electronic devices that can be operated by touching a screen with a finger or pen have been in wide use in recent years. Further, a method by which a plurality of optical sensors are provided at a display panel and an image or a reflected image appearing when a finger or the like comes close to the screen is detected is known as a method for detecting the touch position on the display screen.

The method for detecting the touch position on the display screen by using an optical sensor will be described below with reference to FIG. 20. As shown in FIG. 20, a plurality of thin-film transistors (referred to hereinbelow as TFT) 92 and a plurality of optical sensors 93 are provided in a liquid crystal panel 91. The TFT 92 and optical sensors 93 are two-dimensionally disposed in the liquid crystal panel 91, and a light blocking layer 94 is provided above the TFT 92. A backlight (not shown in the figure) is provided on the rear surface side of the liquid crystal panel 91, and the backlight illuminates the back surface of the liquid crystal panel 91 with light (backlight).

When a finger F comes close to the front surface of the liquid crystal panel 91, the external light falling on the optical sensor 93 is blocked by the finger F, and the backlight is reflected by the surface of the finger F and falls on the optical sensor 93. Therefore, a sensor image is generated on the basis of intensity of light detected by the optical sensor 93, and the touch position on the display screen can be detected by subjecting the sensor image to an image recognition process of detecting the position of the finger F.

The technique relating to the invention of the present application is described in the following patent documents. Patent Document 1 relates to a display system having a light pen and describes that backlight is reflected by the distal end of the light pen and the reflected light is detected by a photosensitive element provided in the display panel. Patent Document 2 describes a portable terminal device incorporating an image sensor, the device including a lens member with an optical path disposed parallel to a transparent panel, a prism member for bending the optical path at a right angle, a light source for irradiating the surface of the display panel with light, and an optical sensor disposed in the focal point of the lens member. Patent Document 3 describes a touch panel including a light guide plate, an optical sensor array with a light receiving surface that faces the side surface of the light guide plate, a lens sheet with a light outgoing surface facing the opposite side surface of the light guide plate, and an illumination means for illuminating the light incidence surface of the lens sheet. Patent Document 4 describes a touch panel in which a light projecting element row and a light receiving element row are arranged on opposite side end surfaces of a pressure-deformable touch panel body composed of anisotropic transparent crystal.

### RELATED ART DOCUMENTS

### Patent Documents

Patent Document 1: Japanese Patent Application Laid-Open Publication No. 2005-85265.
Patent Document 2: Japanese Patent Application Laid-Open Publication No. H9-65028.
Patent Document 3: Japanese Patent Application Laid-Open Publication No. 2000-172444.
Patent Document 4: Japanese Patent Application Laid-Open Publication No. H7-253853.

### SUMMARY OF THE INVENTION

### Problems to be Solved by the Invention

When a touch position on a display screen is detected by an optical sensor, various parameters of the display device should be appropriately adjusted. For example, a parameter controlling the optical sensor, a threshold for extracting a region of a finger or the like from the sensor image, and a parameter used in an image recognition process should be adjusted.

However, in the conventional display devices having optical sensors, the external light falls on the optical sensors. As a result, the intensity of light detected by the optical sensors differs depending on the ambient brightness, and properties of sensor images obtained under bright and dark environments differ significantly. Therefore, where a method is used by which the parameters are determined fixedly, the detection accuracy of the touch position decreases when the environment is bright or dark. Further, even when a method is used by which the parameters are switched dynamically according to the intensity of the external light, since the range of switching the parameters is limited, the detection accuracy of the touch position cannot be significantly increased.

Accordingly, it is an object of the present invention to provide a display device having optical sensors that can eliminate the effect of the external light and detect a touch position on the display screen with high accuracy.

### Means for Solving the Problems

The first aspect of the present invention resides in a display device having a plurality of optical sensors, including:

a display panel including a plurality of pixel circuits disposed two-dimensionally;

a plurality of optical sensors provided in the display panel;

a light source that emits light; and

optical components provided in the display panel for causing the light emitted from the light source to propagate inside the display panel and fall on the optical sensors,

wherein when the front surface of the display panel is pressed, the display panel is deformed, an optical path of the light emitted from the light source changes, and the intensity of light detected by the optical sensor changes.

The second aspect of the present invention resides in the display device according to the first aspect of the present invention, wherein

light reflecting units that reflect light emitted from the light source toward the light sensors are provided as the optical components, and

when the front surface of the display panel is pressed, the reflection direction of light at the light reflecting unit changes.

The third aspect of the present invention resides in the display device according to the second aspect of the present invention, wherein

when the front surface of the display panel is pressed, the inclination of a reflecting surface of the light reflecting unit changes.

The fourth aspect of the present invention resides in the display device according to the second aspect of the present invention, wherein

the light reflecting unit has a curved reflecting surface, and

when the front surface of the display panel is pressed, the distance between the light reflecting unit and the optical sensor changes.

The fifth aspect of the present invention resides in the display device according to the second aspect of the present invention, wherein

the light reflecting unit has a curved reflecting surface, and

when the front surface of the display panel is pressed, the curvature of the reflecting surface changes.

The sixth aspect of the present invention resides in the display device according to the first aspect of the present invention, further including, in the display panel, a light blocking unit that moves onto an optical path leading from the light source to the optical sensor, when the front surface of the display panel is pressed, to prevent the light emitted by the light source from falling on the optical sensor.

The seventh aspect of the present invention resides in the display device according to the sixth aspect of the present invention, wherein

a first light reflecting unit that reflects light emitted from the light source in the direction parallel to the display panel and a second light reflecting unit that reflects light reflected by the first light reflecting unit toward the optical sensor are provided as the optical components, and

the light blocking unit moves onto an optical path between the first light reflecting unit and the second light reflecting unit when the front surface of the display panel is pressed.

The eighth aspect of the present invention resides in the display device according to the first aspect of the present invention, wherein

when the front surface of the display panel is pressed, the light transmission characteristic of the display panel changes in the pressed portion.

The ninth aspect of the present invention resides in the display device according to the eighth aspect of the present invention, wherein

the display panel is a liquid crystal panel in which the space between two substrates is filled with a liquid crystal material, and

when the front surface of the display panel is pressed, the orientation of liquid crystal molecules included in the liquid crystal material changes in the pressed portion.

The tenth aspect of the present invention resides in the display device according to the first aspect of the present invention, further including a light blocking unit that prevents external light from falling on the optical sensor in the display panel.

The eleventh aspect of the present invention resides in the display device according to the first aspect of the present invention, wherein

the light source is a backlight provided on the rear surface side of the display panel.

The twelfth aspect of the present invention resides in the display device according to the first aspect of the present invention, wherein

the light source is a light-emitting element provided in the display panel.

The thirteenth aspect of the present invention resides in the display device according to the first aspect of the present invention, wherein

the display panel is a self-emitting display panel and

a part of the display panel functions as the light source.

The fourteenth aspect of the present invention resides in a display device having a plurality of optical sensors, including:

a display panel including a plurality of pixel circuits disposed two-dimensionally;

a plurality of optical sensors provided in the display panel;

a light source that emits light; and

an optical component provided outside the display panel for causing light emitted from the light source to fall on the optical sensor,

wherein when a detection object comes close to the front surface of the display panel, an optical path leading from the light source to the light sensor is blocked by the detection object and the intensity of light detected by the optical sensor changes.

The fifteenth aspect of the present invention resides in the display device according to the fourteenth aspect of the present invention, wherein

a first light reflecting unit that reflects light emitted from the light source in a direction parallel to the display panel and a second light reflecting unit that reflects light reflected by the first light reflecting unit toward the optical sensor are provided as the optical components such that detection object can be introduced in an optical path between the first light reflecting unit and the second light reflecting unit

### Effects of the Invention

According to the first aspect of the present invention, in the display device in which light emitted from a light source is caused to propagate inside a display panel and the intensity of this light is detected by an optical sensor, when the surface of the display panel is pressed, the optical path of light emitted from the light source and the intensity of light detected by the optical sensor change following the deformation of the display panel. Therefore, by subjecting the sensor image to an image recognition process, it is possible to eliminate the effect of the external light and detect the touch position on the display screen with high accuracy.

According to the second aspect of the present invention, when the front surface of the display panel is pressed, the reflection direction of light in the light reflecting portion changes and the intensity of light detected by the optical sensor changes. Therefore, the effect of the external light can be eliminated and the touch position on the display screen can be detected with high accuracy.

According to the third to fifth aspects of the present invention, when the front surface of the display panel is pressed, the inclination or curvature of the reflecting surface of the light reflecting unit or the distance between the light reflecting unit and the optical sensor changes. Therefore, the effect of the external light can be eliminated and the touch position on the display screen can be detected with high accuracy.

According to the sixth aspect of the present invention, when the front surface of the display panel is pressed, the light blocking unit moves onto an optical path leading from the light source to the optical sensor and the intensity of light detected by the optical sensor changes. Therefore, the effect of the external light can be eliminated and the touch position on the display screen can be detected with high accuracy.

According to the seventh aspect of the present invention, when the front surface of the display panel is pressed, the light blocking unit moves onto an optical path between the first light reflecting unit and the second light reflecting unit and the intensity of light detected by the optical sensor changes. Therefore, the effect of the external light can be eliminated and the touch position on the display screen can be detected with high accuracy.

According to the eighth aspect of the present invention, when the front surface of the display panel is pressed, the light transmission characteristic of the display panel changes in the pressed portion and the intensity of light detected by the optical sensor changes. Therefore, the effect of the external light can be eliminated and the touch position on the display screen can be detected with high accuracy.

According to the ninth aspect of the present invention, when the front surface of the display panel is pressed, the orientation of liquid crystal molecules changes in the pressed portion and the intensity of light detected by the optical sensor changes. Therefore, the effect of the external light can be eliminated and the touch position on the display screen can be detected with high accuracy.

According to the tenth aspect of the present invention, by providing a light blocking unit that prevents external light from falling on the optical sensor, it is possible to eliminate the effect of the external light more effectively and detect the touch position on the display screen with even higher accuracy.

According to the eleventh aspect of the present invention, the touch position on the display screen can be detected using light emitted from the backlight.

According to the twelfth aspect of the present invention, the touch position on the display screen can be detected using light emitted from a light-emitting element provided in the display panel.

According to the thirteenth aspect of the present invention, the touch position on the display screen can be detected using light emitted from a self-emitting display panel.

According to the fourteenth aspect of the present invention, in a display device in which light emitted from a light source is caused to propagate outside the display panel and the intensity of this light is detected by an optical sensor, when a detection object comes close to the front surface of the liquid crystal panel, the optical path leading from the light source to the optical sensor is blocked by the detection object and the intensity of light detected by the optical sensor changes. Therefore, by subjecting the sensor image to an image recognition process, it is possible to eliminate the effect of the external light and detect the touch position on the display screen with high accuracy.

According to the fifteenth aspect of the present invention, the detection object is introduced in an optical path between the first light reflecting unit and the second light reflecting unit. Therefore, the effect of the external light can be eliminated and the touch position on the display screen can be detected with high accuracy.

### BRIEF DESCRIPTION OF THE DRAWINGS

FIG. 1 is a block diagram illustrating the configuration of the display device according to Embodiment 1 to Embodiment 6 of the present invention.

FIG. 2 is a perspective view illustrating a normal state of the liquid crystal panel according to Embodiment 1.

FIG. 3 is a perspective view illustrating a pressed state of the liquid crystal panel according to Embodiment 1.

FIG. 4 illustrates an operational state of the liquid crystal panel according to Embodiment 1.

FIG. 5 illustrates an operational state of the liquid crystal panel according to the first variation example of Embodiment 1.

FIG. 6 illustrates an operational state of the liquid crystal panel according to the second variation example of Embodiment 1.

FIG. 7 illustrates an operational state of the liquid crystal panel according to the third variation example of Embodiment 1.

FIG. 8 illustrates an operational state of the liquid crystal panel according to the fourth variation example of Embodiment 1.

FIG. 9A shows the first example of the cross-sectional shape of the light reflecting unit provided in the liquid crystal panel according to Embodiment 1.

FIG. 9B shows the second example of the cross-sectional shape of the light reflecting unit provided in the liquid crystal panel according to Embodiment 1.

FIG. 9C shows the third example of the cross-sectional shape of the light reflecting unit provided in the liquid crystal panel according to Embodiment 1.

FIG. 9D shows the fourth example of the cross-sectional shape of the light reflecting unit provided in the liquid crystal panel according to Embodiment 1.

FIG. 9E shows the fifth example of the cross-sectional shape of the light reflecting unit provided in the liquid crystal panel according to Embodiment 1.

FIG. 9F shows the sixth example of the cross-sectional shape of the light reflecting unit provided in the liquid crystal panel according to Embodiment 1.

FIG. 9G shows the seventh example of the cross-sectional shape of the light reflecting unit provided in the liquid crystal panel according to Embodiment 1.

FIG. 10 illustrates an operational state of the liquid crystal panel according to Embodiment 2.

FIG. 11 illustrates an operational state of the liquid crystal panel according to a variation example of Embodiment 2.

FIG. 12 illustrates an operational state of the liquid crystal panel according to Embodiment 3.

FIG. 13 illustrates an operational state of the liquid crystal panel according to a variation example of Embodiment 3.

FIG. 14 illustrates an operational state of the liquid crystal panel according to Embodiment 4.

FIG. 15A shows the first example of the cross-sectional shape of the protective sheet provided in the liquid crystal panel according to Embodiment 4.

FIG. 15B shows the second example of the cross-sectional shape of the protective sheet provided in the liquid crystal panel according to Embodiment 4.

FIG. 16 illustrates an operational state of the liquid crystal panel according to Embodiment 5.

FIG. 17 illustrates the structure of the light-emitting element provided in the liquid crystal panel according to Embodiment 5.

FIG. 18 illustrates an operational state of the liquid crystal panel according to a variation example of Embodiment 5.

FIG. 19 is a cross-sectional view illustrating the structure of the organic EL panel according to Embodiment 6.

FIG. 20 illustrates a method for detecting the touch position on the display screen by using an optical sensor.

### DETAILED DESCRIPTION OF EMBODIMENTS

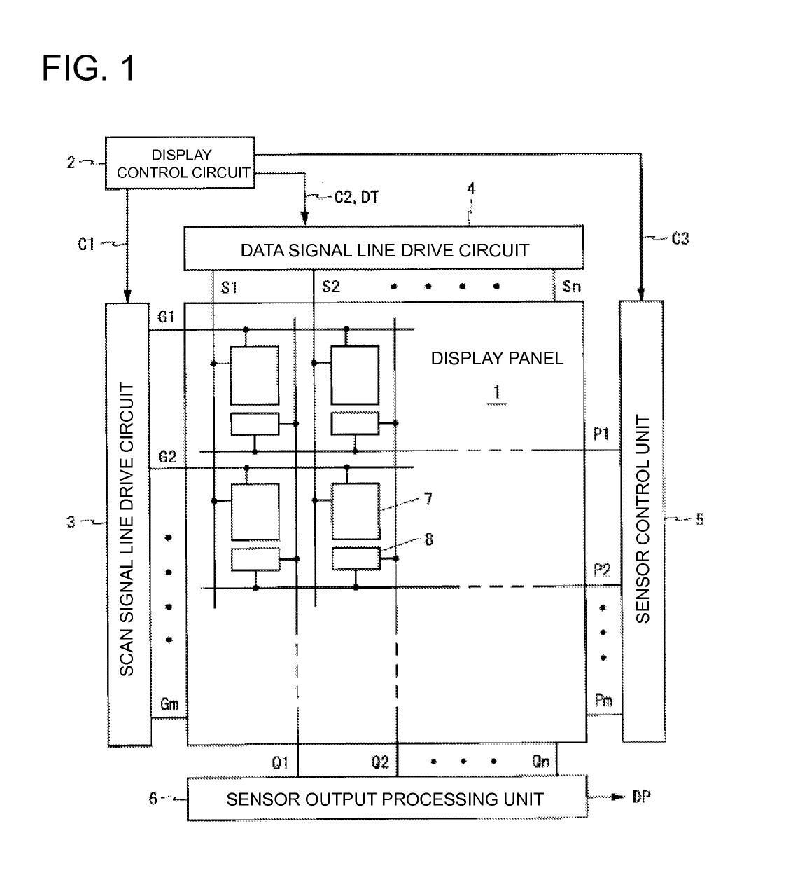

FIG. 1 is a block diagram illustrating the configuration of display devices of Embodiment 1 to Embodiment 6 of the present invention. The display device shown in FIG. 1 is provided with a display panel 1, a display control circuit 2, a scan signal line drive circuit 3, a data signal line drive circuit 4, a sensor control circuit 5, and a sensor output processing circuit 6. This display device has a function of detecting a touch position on the display screen in addition to a screen display function. In the description below, m and n are integers equal to or greater than 2.

A total of m mutually parallel scan signal lines G1 to Gm and n mutually parallel data signal lines S1 to Sn, which are perpendicular to the scan signal lines, are provided at the display panel 1. A pixel circuit 7 functioning as a display element is provided correspondingly to each intersection point of the scan signal lines G1 to Gm and data signal lines S1 to Sn. Further, in the display panel 1, a total of m sensor control lines P1 to Pm are provided parallel to the scan signal lines G1 to Gm and a total of n sensor output lines Q1 to Qn are provided parallel to the data signal lines S1 to Sn. A sensor circuit 8 including an optical sensor is provided correspondingly to each intersection point of the sensor control lines P1 to Pm and sensor output lines Q1 to Qn. Thus, the display panel 1 includes a plurality of display circuits 7 disposed two dimensionally, and sensor circuits 8 are provided together with the pixel circuits 7 in the display panel 1. In the display devices of Embodiment 1 to Embodiment 4, a backlight (not shown in the figure) is provided at the back surface side of the display panel 1, and the backlight emits backlight on the back surface of the display panel 1.

The display control circuit 2 outputs a control signal C1 to the scan signal line drive circuit 3, outputs a control signal C2 and a video signal DT to the data signal line drive circuit 4, and outputs a control signal C3 to the sensor control circuit 5. The scan signal line drive circuit 3 selects one scan signal line from among the scan signal lines G1 to Gm according to the control signal C1 and applies a gate ON voltage (a voltage at which a write TFT located in the display circuit 7 assumes the ON state) to the selected scan signal line. The data signal line drive circuit 4 applies a voltage corresponding to the video signal DT to the data signal lines S1 to Sn according to the control signal C2. As a result, pixel circuits 7 of one row are selected, the voltage corresponding to the video signal DT is written to the selected pixel circuits 7, and the desired image can be displayed.

The sensor control circuit 5 selects one sensor control line from among the sensor control lines P1 to Pm according to the control signal C3 and applies a gate ON voltage (a voltage at which a write TFT located in the sensor circuit 8 assumes the ON state) to the selected sensor control line. As a result, sensor circuits 8 of one row are selected, and a signal corresponding to the intensity of light detected by the selected sensor circuits 8 can be outputted via the sensor output lines Q1 to Qn to the outside of the display panel 1. The sensor output processing circuit 6 generates a sensor image on the basis of the signal outputted from the display panel 1 and subjects the sensor image to an image recognition process for detecting the position of a detection object (finger or the like). The sensor output processing circuit 6 finds a touch position on the display screen by the image recognition process and outputs position data DP indicating the touch position.

Specific features of the display device of the embodiments of the present invention are in the configuration of the display panel. Accordingly, the display panels included in the display devices of the embodiments will be described below in greater detail. The state in which the front surface of the display panel is not pressed will be referred to herein as “normal state,” the state in which the front surface of the display panel is pressed will be referred to herein as “pressed state,” and the normal state and the pressed state will be referred to together as the “operational state.”

### Embodiment 1

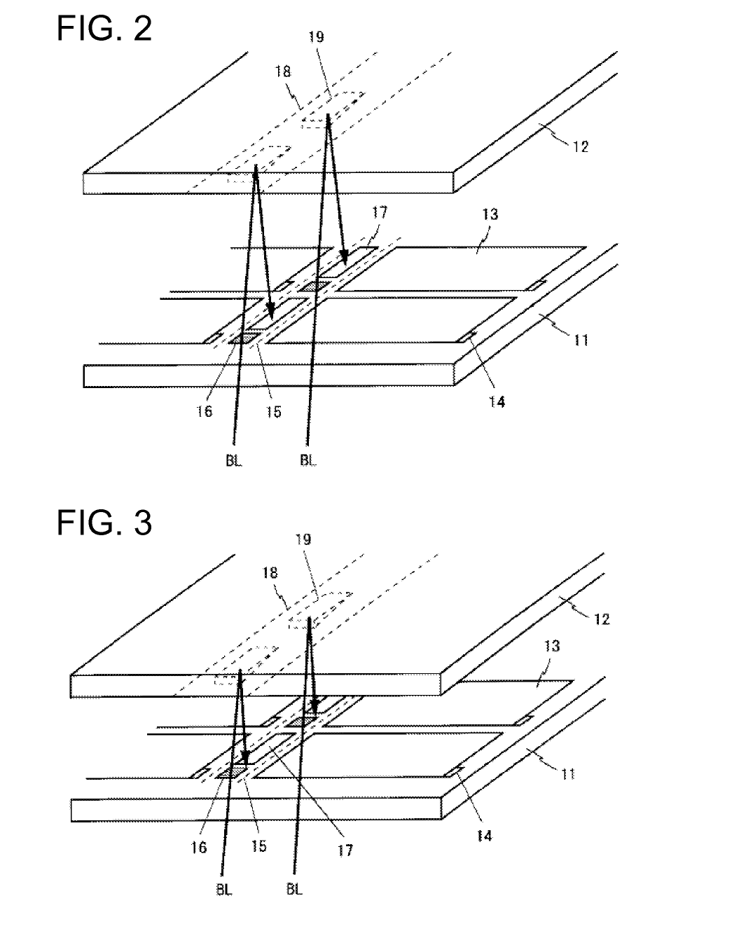

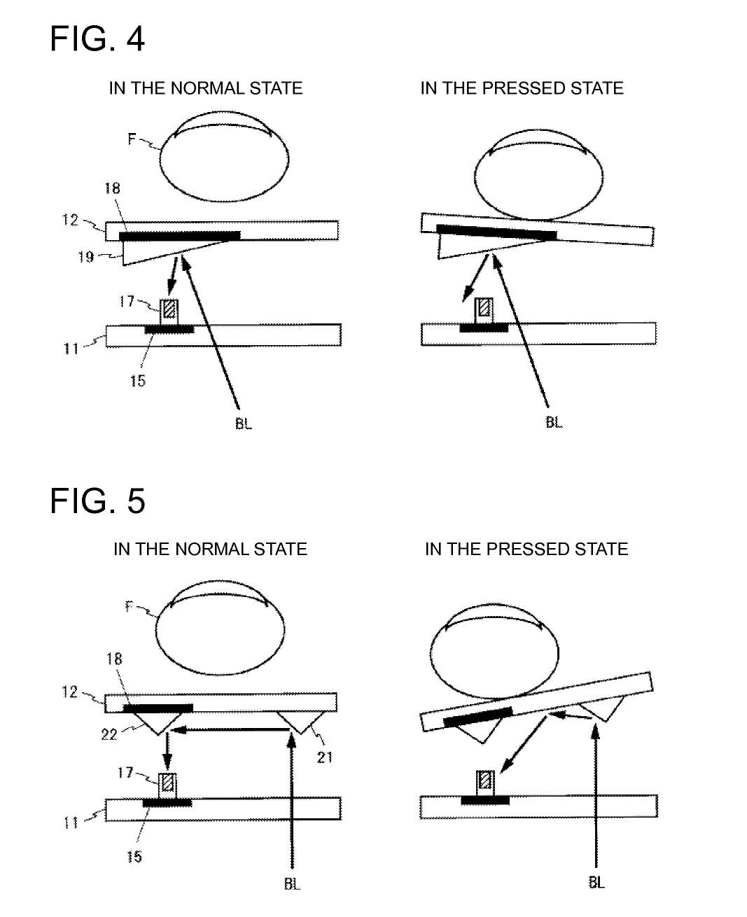

FIG. 2 and FIG. 3 are perspective views illustrating the structure of the liquid crystal panel according to Embodiment 1 of the present invention. FIG. 2 illustrates a normal state and FIG. 3 illustrates a pressed state. FIG. 4 illustrates an operational state of the liquid crystal panel according to the present embodiment. FIG. 4 shows schematically a cross section of the liquid crystal panel. In the drawings illustrating the operational state of the liquid panel, a finger F is shown smaller than it actually is.

As shown in FIG. 2, the liquid crystal panel according to the present embodiment is provided with a TFT-side substrate 11 and an opposite substrate 12. The TFT-side substrate 11 and the opposite substrate 12 are arranged directly opposite each other, and the space between the two substrates is filled with a liquid crystal material (not shown in the figure). The TFT-side substrate 11 can be also called an active matrix substrate.

The TFT-side substrate 11 is provided with pixel electrodes 13, TFTs 14, light blocking layers 15, light blocking layer openings 16, and optical sensors 17. The pixel electrode 13 and TFT 14 are included in the pixel circuit 7 shown in FIG. 1, and the optical sensor 17 is included in the sensor circuit 8 shown in FIG. 1. The pixel electrodes 13 and TFTs 14 are arranged two dimensionally on the TFT-side substrate 11. The light blocking layer 15 is provided between two pixel electrodes 13 adjacent in the longitudinal direction (that is, in a portion between the two broken lines in the figure). The light blocking layer 15 is provided with the light blocking layer opening 16 for allowing the light to pass therethrough. The optical sensor 17 is disposed in the vicinity of the light blocking layer opening 16 within a formation region of the light blocking layer 15.

The opposite substrate 12 is provided with an opposite electrode (not shown in the figure), light blocking layers 18, and light reflecting units 19. The light blocking layers 18 are provided at positions opposite respective light blocking layers 15 (that is, in portions between the two broken lines in the figure) and have a width larger than that of the light blocking layers 15. The light reflecting units 19 are provided in a predetermined positional relationship (described hereinbelow) between the light blocking layer openings 16 and optical sensors 17 within the formation regions of the light blocking layers 18. In addition to the light blocking layers 18, light blocking layers (not shown in the figure) are also provided above the TFTs 14. The backlight (not shown in the figure) provided on the back surface side of the liquid crystal panel emits backlight BL onto the rear surface of the liquid crystal panel. The light reflecting units 19 function as optical components for causing the backlight BL to propagate inside the liquid crystal panel and fall on the optical sensors 17.

In FIG. 4, the hatched portion represents a light receiving portion of the optical sensor 17. As shown on the left side in FIG. 4, the light reflecting unit 19 is disposed so that the backlight BL that has passed through the TFT-side substrate 11 (more specifically, the light blocking layer opening 16 provided at the TFT-side substrate 11) in the normal state is reflected by the light reflecting unit 19 and falls on the optical sensor 17. Therefore, in the normal state, the reflected light of the backlight BL falls on the optical sensor 17 and the intensity of this light detected by the optical sensor 17 is at a predetermined level. Further, since the optical sensor 17 is covered by the light blocking layer 18 provided on the opposite substrate 12, the external light does not fall on the optical sensor 17. Moreover, since the optical sensor 17 is disposed in the formation region of the light blocking layer 15 on the TFT-side substrate 11, the backlight BL cannot directly fall on the optical sensor 17.

The user touches the front surface (upper surface in the figure) of the opposite substrate 12, for example, with the finger F. Where the finger F touches the opposite substrate 12, a force is applied to the opposite substrate 12 and the liquid crystal panel is deformed. As a result, the distance between the TFT-side substrate 11 and the opposite substrate 12 decreases (see FIG. 3) and the inclination of the light reflecting unit 19 changes (see right side in FIG. 4). Accordingly, the optical path of the backlight BL passing through the TFT-side substrate 11 changes and the reflected light of the backlight BL is unlikely to fall on the optical sensor 17. As a result, the intensity of light that is detected by the optical sensor 17 is reduced.

As a consequence, the sensor image in the pressed state becomes darker in the vicinity of the touch position. In this case, the touch position on the display screen can be detected by subjecting the sensed image to an image recognition process of detecting the position of the detection object (finger or the like). Further, since the touch position is detected without using the external light, the detection accuracy of the touch position is not decreased under the effect of the external light. Therefore, with the liquid crystal display device according to the present embodiment, the effect of the external light can be eliminated and the touch position on the display screen can be detected with high accuracy.

The following variation examples can be configured with respect to the present embodiment. FIG. 5 to FIG. 8 show the operational states of liquid crystal panels of the first to fourth variation examples of Embodiment 1. In the liquid crystal panel shown in FIG. 5, two light reflecting units 21, 22 are provided on the opposite substrate 12 in order to cause the backlight BL to propagate inside the liquid crystal panel and fall on the optical sensor 17. The light reflecting unit 21 is provided above the light blocking layer opening, and the light reflecting unit 22 is provided above the optical sensor 17. In the normal state, the backlight BL that has passed through the TFT-side substrate 11 is reflected by the light reflecting unit 21, propagates parallel to the opposite substrate 12, undergoes reflection by the light reflecting unit 22, and falls on the optical sensor 17 (see left side in FIG. 5). In the pressed state, since the inclination of the light reflecting units 21, 22 changes, the optical path of the backlight BL that has passed through the TFT-side substrate 11 also changes and the quantity of light detected by the optical sensor 17 is reduced (see right side in FIG. 5).

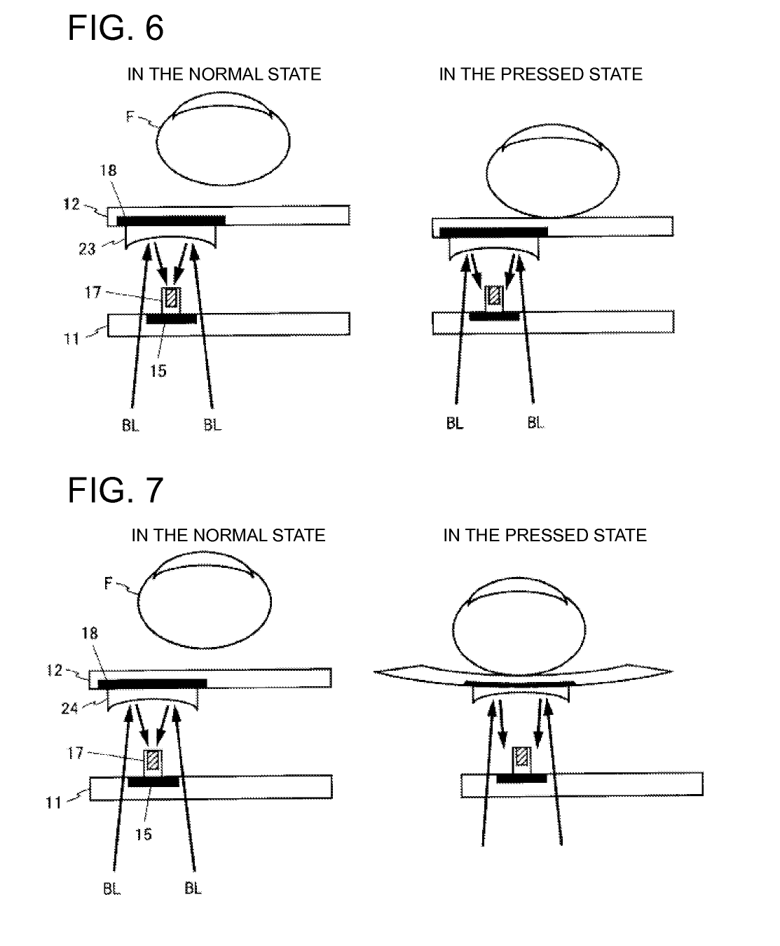

In the liquid crystal panel shown in FIG. 6, a light reflecting unit 23 having a concave reflecting surface is provided on the opposite substrate 12 so as to cause the backlight BL to propagate inside the liquid crystal panel and fall on the optical sensor 17. The light reflecting unit 23 is provided above the optical sensor 17. In the normal state, the backlight BL that has passed through the TFT-side substrate 11 is reflected by the light reflecting unit 23 and falls on the optical sensor 17 (see left side in FIG. 6). In the pressed state, the distance between the TFT-side substrate 11 and the light reflecting unit 23 decreases and the reflection direction of light on the light reflecting unit 23 changes accordingly. As a result, the optical path of the backlight BL that has passed through the TFT-side substrate 11 changes and the quantity of light detected by the optical sensor 17 is reduced (see right side in FIG. 6).

In the liquid crystal panel shown in FIG. 7, a light reflecting unit 24 having a concave reflecting surface is provided on the opposite substrate 12 in the same manner as in the liquid crystal panel shown in FIG. 6. In the normal state, the backlight BL that has passed through the TFT-side substrate 11 is reflected by the light reflecting unit 24 and falls on the optical sensor 17 (see left side in FIG. 7). In the pressed state, the opposite substrate 12 curves since a force is applied thereto, the curvature radius of the reflecting surface of the light reflecting unit 24 changes accordingly, and the reflection direction of light on the light reflecting unit 24 changes. As a result, the optical path of the backlight BL that has passed through the TFT-side substrate 11 changes and the quantity of light detected by the optical sensor 17 is reduced (see right side in FIG. 7).

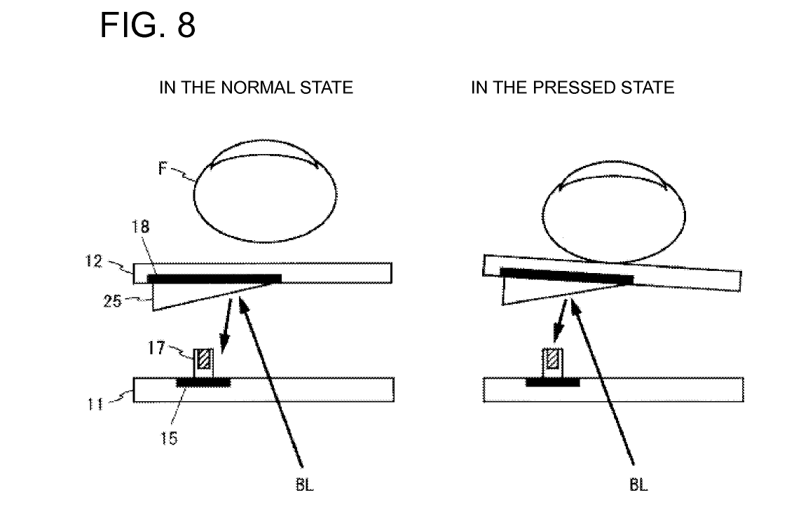

In the liquid crystal panel shown in FIG. 8, a light reflecting unit 25 is provided on the opposite substrate 12 in the same manner as in the liquid crystal panel shown in FIG. 4. The light reflecting unit 25 is disposed so that in the normal state, the backlight BL reflected by the light reflecting unit 25 does not fall on the optical sensor 17 (see left side in FIG. 8), whereas in the pressed state, the reflected light falls on the optical sensor 17 (see right side in FIG. 8). In the liquid crystal panel shown in FIG. 8, the optical path of the backlight BL that has passed through the TFT-side substrate 11 in the pressed state changes and the quantity of light detected by the optical sensor 17 is increased. By using the liquid crystal panels of these variation examples, it is also possible to eliminate the effect of the external light and detect the touch position on the display screen with high accuracy.

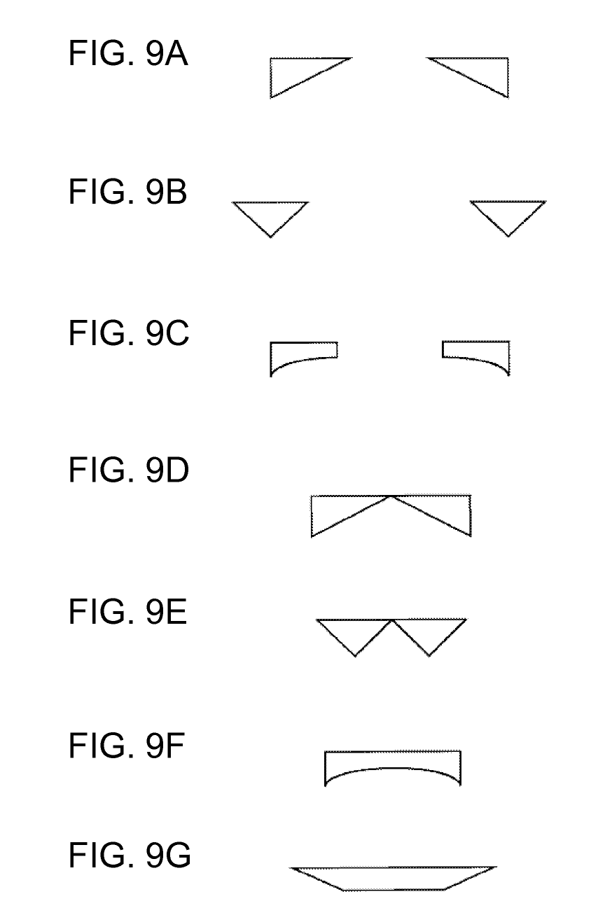

The light reflecting unit mentioned hereinabove can be formed, for example, by using a resin. Further, a metal such as aluminum may be deposited on the light reflecting unit formed from a resin or the like in order to increase light reflection efficiency. The light reflecting unit may take any appropriate shape. FIGS. 9A to 9G show examples of cross-sectional shape of the light reflecting unit. The light reflecting unit can have one flat reflecting surface (FIG. 9A), two flat reflecting surfaces (FIG. 9B), a curved reflecting surface (FIG. 9C), and a reflecting surface obtained by connecting two of the above-mentioned surfaces (FIG. 9D to FIG. 9F). Further, as shown in FIG. 9G, a unit obtained by tapering a wiring pattern formed on the opposite substrate 12 can be also used as the light reflecting unit. The shapes of the light reflecting units may be such that they change when pressed. By using such light reflecting units, it is also possible to eliminate the effect of the external light and detect the touch position on the display screen with high accuracy, in the same manner as in the case illustrated in FIG. 7.

In the above-described liquid crystal panels, the light blocking layer 18 is provided above the optical sensor 17 in order to prevent the external light from falling on the optical sensor 17. However, from the standpoint of the principle of the present invention, it is not always necessary to provide the light blocking layer 18. Even when the light blocking layer 18 is not provided, the touch position on the display screen can be detected by using the reflected light of the backlight BL. By providing the light blocking layer 18, it is possible to eliminate the effect of the external light more effectively and detect the touch position on the display screen with even higher accuracy.

As shown hereinabove, with the liquid crystal display device according to the present embodiment, in the configuration in which the backlight is caused to propagate inside the liquid crystal panel and the intensity of this light is detected with optical sensors, when the front surface of the liquid crystal panel is pressed, the reflection direction of light on the light reflecting unit, the optical path of the backlight, and the intensity of light detected by optical sensor change following the deformation of the liquid crystal panel. Therefore, the effect of the external light can be eliminated and the touch position on the display screen can be detected with high accuracy.

### Embodiment 2

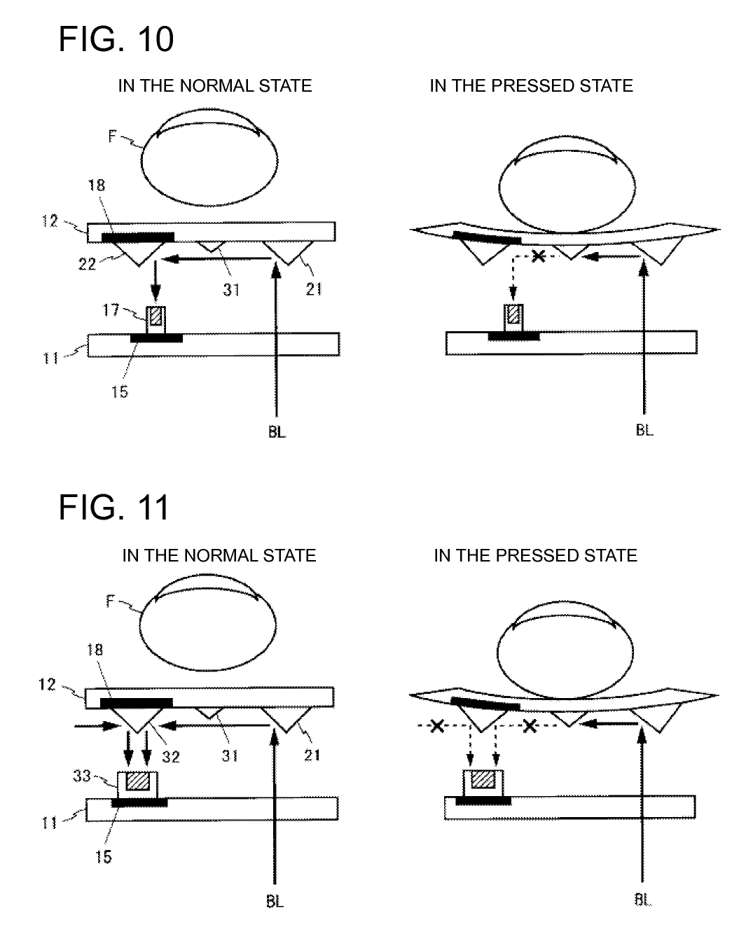

FIG. 10 shows the operational state of the liquid crystal panel according to Embodiment 2 of the present invention. As shown in FIG. 10, the liquid crystal panel according to the present embodiment is obtained by adding a blocking protrusion 31 to the liquid crystal panel shown in FIG. 5. The blocking protrusion 31 is provided between the light reflecting units 21 and 22 on the opposite substrate 12, and when the front surface of the liquid crystal panel is pressed, the blocking protrusion 31 functions as a light blocking portion moving onto the optical path between the light reflecting units 21, 22.

The blocking protrusion 31 is provided at a position such that the backlight BL that has passed through the TFT-side substrate 11 in the normal state is not prevented from being reflected by the light reflecting units 21, 22 and falling on the optical sensor 17 (see left side in FIG. 10). In the pressed state, the opposite substrate 12 is curved since a force is applied thereto, and the blocking protrusion 31 moves closer to the TFT-side substrate 11. As a result, the blocking protrusion 31 moves onto the optical path between the light reflecting units 21, 22 in the pressed state and prevents the backlight BL that has passed through the TFT-side substrate 11 from being reflected by the light reflecting units 21, 22 and falling on the optical sensor 17 (see right side in FIG. 10). Therefore, the optical path of the backlight BL that has passed through the TFT-side substrate 11 changes and the quantity of light detected by the optical sensor 17 is reduced. Therefore, by subjecting the sensor image to an image recognition process, it is possible to eliminate the effect of the external light and detect the touch position on the display screen with high accuracy in a manner similar to Embodiment 1.

A variation example shown in FIG. 11 can be configured with respect to the present embodiment. In the liquid crystal panel shown in FIG. 11, a light reflecting unit 32 having two reflecting surfaces is provided, and the light reflecting unit 21 and another light reflecting unit (not shown in the figure) are provided so that the light reflecting unit 32 is located therebetween. The reflected light obtained by reflection of the backlight BL that has passed through the TFT-side substrate 11 at the light reflecting unit 21 is reflected by one reflecting surface of the light reflecting unit 32, and the other reflected light obtained by reflection of the backlight BL that has passed through the TFT-side substrate 11 at the other light reflecting unit is reflected by the other reflecting surface of the light reflecting unit 32. An optical sensor 33 detects the intensity of light reflected by the two reflecting surfaces of the light reflecting unit 32. The effect obtained by using the liquid crystal panel of the present variation example is similar to that obtained with the liquid crystal panel shown in FIG. 10.

As shown hereinabove, with the liquid crystal display device according to the present embodiment, in the configuration in which the backlight is caused to propagate inside the liquid crystal panel and the intensity of this light is detected with optical sensors, when the front surface of the liquid crystal panel is pressed, the light blocking unit moves onto the optical path of the backlight and the intensity of light detected by the optical sensor changes following the deformation of the liquid crystal panel. Therefore, the effect of the external light can be eliminated and the touch position on the display screen can be detected with high accuracy.

### Embodiment 3

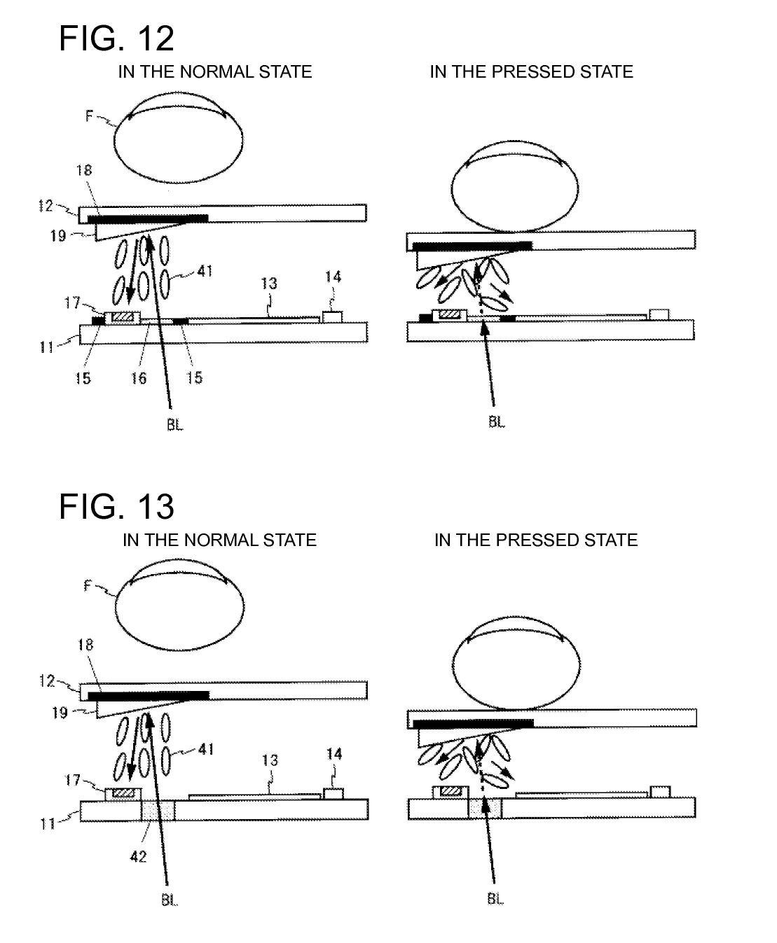

FIG. 12 illustrates the operational state of the liquid crystal panel according to Embodiment 3 of the present invention. As shown in FIG. 12, the liquid crystal panel according to the present embodiment has a structure similar to that of the liquid crystal panel according to Embodiment 1. The positional relationship of the light blocking layer opening 16, optical sensor 17, and light reflecting unit 19 is similar to that of Embodiment 1. In FIG. 12, the cross section of the liquid crystal panel is shown in greater detail than in other figures.

As shown in FIG. 12, the space between the TFT-side substrate 11 and the opposite substrate 12 is filled with a liquid crystal material including liquid crystal molecules 41. In the normal state, the liquid crystal molecules 41 are oriented, for example, in the perpendicular direction. Therefore, in the normal state, the backlight BL that has passed through the TFT-side substrate 11 passes without scattering through the space where the liquid crystal molecules 41 are arranged and falls on the optical sensor 17 upon reflection by the light reflecting unit 19 (see left side in FIG. 12).

Fine peaks and valleys are present on the surface of the TFT-side substrate 11 in the vicinity of the optical sensor 17. As a result, the orientation of the liquid crystal molecules 41 is slightly disturbed in the vicinity of the optical sensor 17. In the pressed state, the distance between the TFT-side substrate 11 and the opposite substrate 12 decreases and an electric field from the pixel electrode 13 is intensified. When the electric field is intensified, the disturbance of orientation of the liquid crystal molecules 41 in the vicinity of the optical sensor 17 increases and the transmissivity of the liquid crystal decreases. As a result, in the pressed state, the backlight BL that has passes through the TFT-side substrate 11 is scattered inside the space in which the liquid crystal molecules 41 are arranged, and the quantity of light detected by the optical sensor 17 decreases (see right side in FIG. 12). Therefore, similarly to Embodiment 1 and Embodiment 2, by subjecting the sensor image to an image recognition process, it is possible to eliminate the effect of the external light and detect the touch position on the display screen with high accuracy.

A variation example shown in FIG. 13 can be configured with respect to the present embodiment. In the liquid crystal panel shown in FIG. 13, the light blocking layer in the TFT-side substrate 11 is formed integrally with the TFT-side substrate 11, and a portion where the light blocking layer has not been formed serves as the light blocking layer opening 42. The effect obtained by using the liquid crystal panel of this variation example is similar to that obtained with the liquid crystal panel shown in FIG. 12.

As shown above, with the liquid crystal display device according to the present embodiment, in the configuration in which the backlight is caused to propagate inside the liquid crystal panel and the intensity of this light is detected with optical sensors, when the front surface of the liquid crystal panel is pressed, the light transmission characteristic of the liquid crystal panel changes and the intensity of light detected by the optical sensor changes following the deformation of the liquid crystal panel. Therefore, the effect of the external light can be eliminated and the touch position on the display screen can be detected with high accuracy.

### Embodiment 4

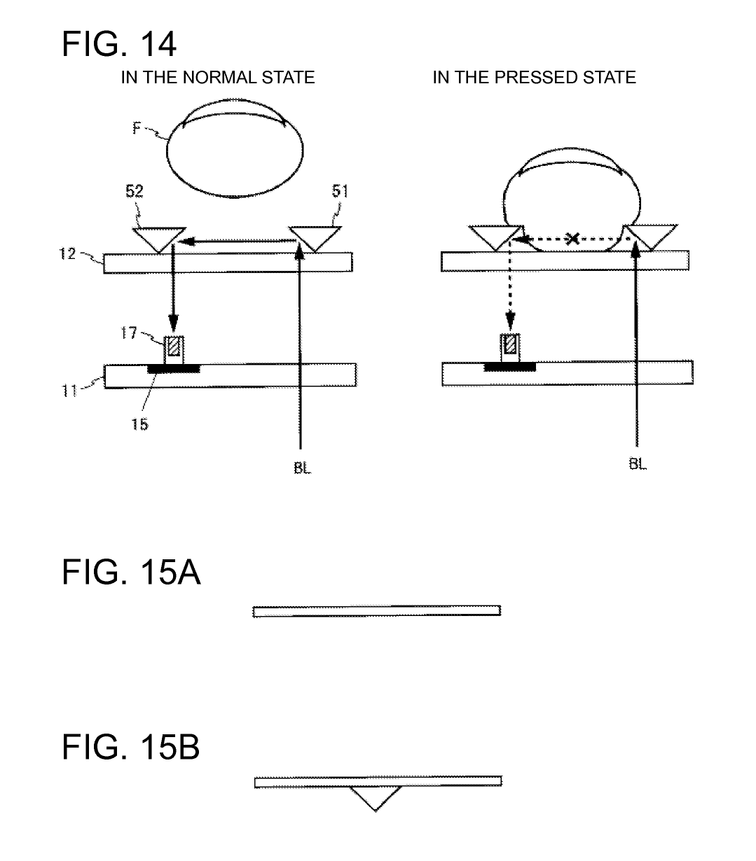

FIG. 14 illustrates the operational state of the liquid crystal panel according to Embodiment 4 of the present invention. As shown in FIG. 14, in the liquid crystal panel according to the present embodiment, two light reflecting units 51, 52 are provided outside the opposite substrate 12 (more specifically on the surface of the opposite substrate 12 that is not facing the TFT-side substrate 11). The light reflecting unit 51 is provided above the light blocking layer opening, and the light reflecting unit 52 is provided above the optical sensor 17. The light reflecting units 51, 52 function as optical components that cause the backlight BL to fall on the optical sensor 17.

In the present embodiment, the backlight BL that has passed through the TFT-side substrate 11 passes through the opposite substrate 12. In the normal state, the backlight BL that has passed through the opposite substrate 12 is reflected by the light reflecting unit 51, propagates parallel to the opposite substrate 12, then undergoes reflection on the light reflecting unit 52, passes again through the opposite substrate 12 and falls on the optical sensor 17 (see left side on FIG. 14).

In the pressed state, the finger F deforms according to the outer shape of the opposite substrate 12 and the light reflecting units 51, 52, and part of the finger F enters the optical path between the light reflecting units 51, 52. The finger F thus prevents the backlight BL that has passed through the opposite substrate 12 from falling on the optical sensor 17 upon reflection at the light reflecting units 51, 52 (see right side in FIG. 14). Therefore, the optical path of the backlight BL that has passed through the TFT-side substrate 11 and the opposite substrate 12 changes and the quantity of light detected by the optical sensor 17 decreases.

Therefore, similar to Embodiment 1 to Embodiment 3, by subjecting the sensor image to an image recognition process, it is possible to eliminate the effect of the external light and detect the touch position on the display screen with high accuracy. Further, in the present embodiment, the touch position on the display screen can be detected when the detection object (finger or the like) comes close to the front surface of the liquid crystal panel, even when no pressure is applied to the front surface of the liquid crystal panel.

The liquid crystal panel shown in FIG. 14 may be provided with a protective sheet that covers the outer surface of the opposite substrate 12. FIGS. 15A and 15B illustrate examples of cross-sectional shape of the protective sheet. Thus, the protective sheet may be in the form of a sheet (FIG. 15A), or blocking protrusions may be provided on a sheet (FIG. 15B), or a polarizing plate or protective sheet may be formed integrally with the opposite substrate.

As shown above, with the liquid crystal display device according to the present embodiment, in the configuration in which the backlight is caused to propagate inside the liquid crystal panel and the intensity of this light is detected with optical sensors, when a detection object comes close to the front surface of the liquid crystal panel, the optical path leading from the light source to the optical sensor is blocked by the detection object and the intensity of light detected by the optical sensor changes. Therefore, the effect of the external light can be eliminated and the touch position on the display screen can be detected with high accuracy.

### Embodiment 5

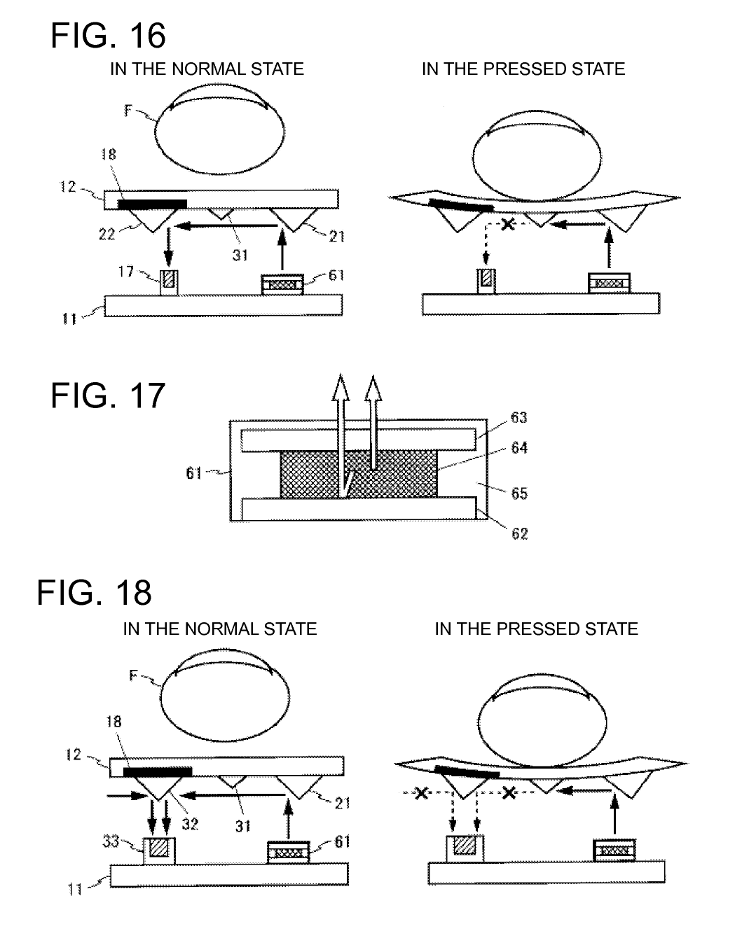

FIG. 16 illustrates the operational state of the liquid crystal panel according to Embodiment 5 of the present invention. As shown in FIG. 16, the liquid crystal panel according to the present embodiment is obtained by additionally providing the liquid crystal panel shown in FIG. 5 with a light-emitting element 61. The light-emitting element 61 is disposed on the TFT-side substrate 11 below the light reflecting unit 21. The liquid crystal display device according to the present embodiment may or may not be provided with a backlight.

FIG. 17 shows the structure of the light-emitting element 61. As shown in FIG. 17, the light-emitting element 61 has a structure in which a light-emitting layer 64 is sandwiched between a positive electrode 62 and a negative electrode 63, and these components are covered by a protective layer 65. The negative electrode 63 is a transparent electrode. In most light-emitting elements 61, the surface of the positive electrode 62 on the side of the light-emitting layer 64 has light reflectivity in order to increase light emission efficiency. The light-emitting layer 64 emits light toward the negative electrode 63 and emits light toward the positive electrode 62. The former passes through the negative electrode 63 and is outputted to the outside of the light-emitting element 61, and the latter is reflected by the front surface of the positive electrode 62 and outputted to the outside of the light-emitting element 61 upon passing through the negative electrode 63.

In the normal state, the light emitted from the light-emitting element 61 is reflected by the light reflecting unit 21 and propagates parallel to the opposite substrate 12. Then, the light is reflected by the light reflecting unit 22 and falls on the optical sensor 17 (see left side in FIG. 16). In the pressed state, the opposite substrate 12 is curved and the light blocking protrusion 31 moves onto the optical path between the light reflecting units 21 and 22. As a result, the optical path of light emitted from the light-emitting element 61 changes and the quantity of light detected by the optical sensor 17 decreases (see right side in FIG. 16). Therefore, similar to Embodiment 1 to Embodiment 4, by subjecting the sensor image to an image recognition process, it is possible to eliminate the effect of the external light and detect the touch position on the display screen with high accuracy.

As shown above, with the liquid crystal display device according to the present embodiment, the touch position on the display screen can be detected by using the light emitted from the light-emitting element provided in the liquid crystal panel, instead of the backlight. A light-emitting element may be additionally provided in a liquid crystal panel other than the liquid crystal panel shown in FIG. 5. For example, when the light-emitting element 61 is additionally provided in the liquid crystal panel shown in FIG. 11, the operational state of the liquid crystal panel becomes that shown in FIG. 18.

### Embodiment 6

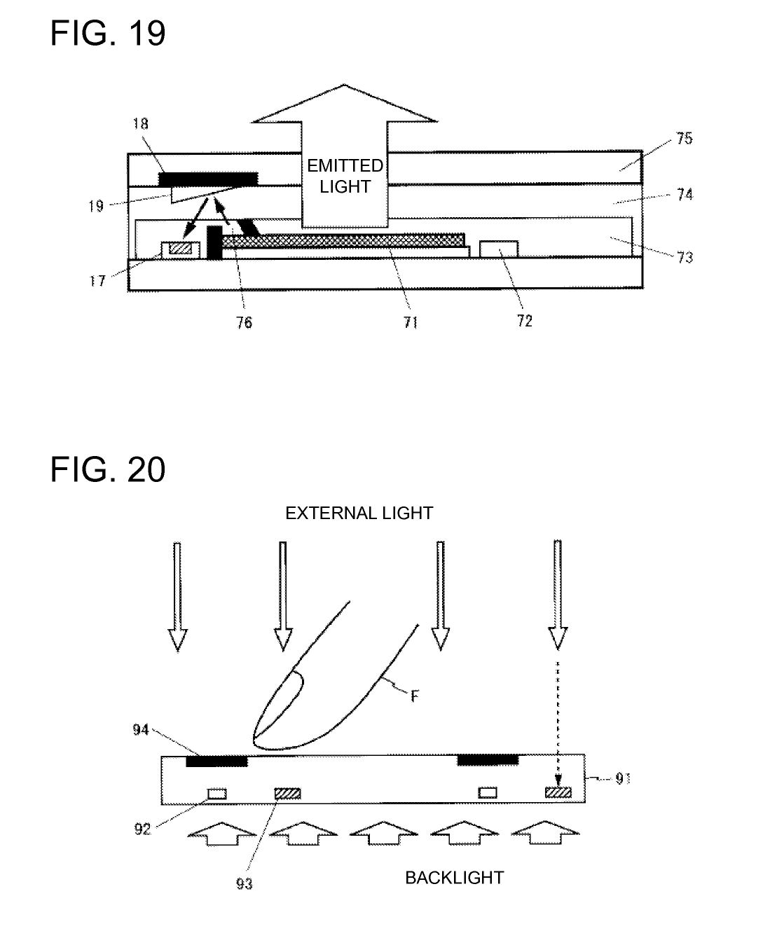

FIG. 19 shows the structure of an organic EL (Electro Luminescence) panel according to Embodiment 6 of the present invention. As shown in FIG. 19 in the organic EL panel according to the present embodiment, a structure including a light blocking layer 73, a first protective layer 74, and a second protective layer 75 is provided on a light-emitting layer 71 and an array element 72. A light blocking layer opening 76 is provided in the light blocking layer 73, and the optical sensor 17, light blocking layer 18, and light reflecting unit 19 are provided at the vicinity of the light blocking layer opening 76. The EL display device according to the present embodiment is not provided with a backlight.

The organic EL panel shown in FIG. 19 is a self-emitting display panel having the light-emitting layer 71. The array element 72 is, for example, a TFT that controls a pixel circuit provided on the organic EL panel. The light blocking layer 73 has a function of increasing the protective ability and a function of imparting the optical sensor 17 with directivity. The first protective layer 74 has a certain thickness and flexibility. By using the first protective layer 74 having a certain thickness, it is possible to cause the light emitted from the light-emitting layer 71 to fall on the optical sensor 17. Where the flexible first protective layer 74 is used, when the front surface of the organic EL panel is pressed, the distance between the optical sensor 17 and the light reflecting unit 19 changes. The second protective layer 75 is, for example, a hard cover for protecting the organic EL panel from damage and moisture. The light blocking layer 73, first protective layer 74, and second protective layer 75 may be provided in any sequence.

Part of light emitted from the light emitting layer 71 is transmitted via the light blocking layer opening 76. The optical sensor 17 and the light reflecting unit 19 are disposed so that in the normal state the light that has passed through the light blocking layer opening 76 is reflected by the light reflecting unit 19 and falls on the optical sensor 17, but in the pressed state, the light does not fall on the optical sensor 17. Therefore, in the pressed state, the optical path of light emitted from the light-emitting layer 71 changes and the quantity of light detected by the optical sensor 17 decreases. As a result, similar to Embodiment 1 to Embodiment 5 by subjecting the sensor image to an image recognition process, it is possible to eliminate the effect of the external light and detect the touch position on the display screen with high accuracy.

As shown above, with the liquid crystal display device according to the present embodiment, the touch position on the display screen can be detected by using the light emitted from the self-emitting display panel instead of the backlight.

In the description above, an optical sensor is provided for each pixel circuit in the display panel, but any number of optical sensors may be provided in the display panel. For example, an optical sensor can be provided for two or more pixel circuits. Further, wirings of any type may be provided in any form for the optical sensors, as long as the necessary signals can be provided to the optical sensors and the signals outputted from the optical sensors can be outputted to the outside of the display panel. Features of the embodiments may be combined as needed as long as their properties thereof are not affected, to structure a display device provided with optical sensors that has a combination of these feature.

### INDUSTRIAL APPLICABILITY

The display device in accordance with the present invention makes it possible to eliminate the effect of the external light and detect the touch position on the display screen with high accuracy, and therefore can be used as a display device capable of detecting a touch position in a variety of electronic devices.

### DESCRIPTION OF REFERENCE CHARACTERS

1 . . . display panel
7 . . . pixel circuit
8 . . . sensor circuit
11 . . . TFT-side substrate
12 . . . opposite substrate
13 . . . pixel electrode
14 . . . TFT
15, 18, 73 . . . light blocking layers
16, 42, 76 . . . light blocking layer opening
17, 33 . . . optical sensors
19, 21-25, 32, 51, 52 . . . light reflecting unit
31 . . . blocking protrusion
41 . . . liquid crystal molecule
61 . . . light-emitting element
71 . . . light-emitting layer
BL . . . backlight
F . . . finger.

1. A display device having a plurality of optical sensors, comprising:
a display panel including a plurality of pixel circuits disposed two-dimensionally;
a plurality of optical sensors provided in said display panel;
a light source that emits light; and
optical components provided in said display panel for causing light emitted from said light source to propagate inside said display panel and fall on said optical sensors,
wherein when a front surface of said display panel is pressed, said display panel is deformed, an optical path of the light emitted from said light source changes, and an intensity of light detected by said optical sensor changes.

2. The display device according to claim 1, wherein
light reflecting units that reflect light emitted from said light source toward said light sensors are provided as said optical components, and
when the front surface of said display panel is pressed, a reflection direction of light at said light reflecting unit changes.

3. The display device according to claim 2, wherein when the front surface of said display panel is pressed, an inclination of a reflecting surface of said light reflecting unit changes.

4. The display device according to claim 2, wherein
said light reflecting unit has a curved reflecting surface, and
when the front surface of said display panel is pressed, a distance between said light reflecting unit and said optical sensor changes.

5. The display device according to claim 2, wherein
said light reflecting unit has a curved reflecting surface, and
when the front surface of said display panel is pressed, a curvature of said reflecting surface changes.

6. The display device according to claim 1, wherein said display panel further comprises a light blocking unit that moves onto an optical path leading from said light source to said optical sensor to prevent the light emitted by said light source from falling on said optical sensor, when the front surface of said display panel is pressed.

7. The display device according to claim 6, wherein
a first light reflecting unit that reflects light emitted from said light source in a direction parallel to said display panel and a second light reflecting unit that reflects light reflected by said first light reflecting unit toward said optical sensor are provided as said optical components, and
said light blocking unit moves onto an optical path between said first light reflecting unit and said second light reflecting unit when the front surface of said display panel is pressed.

8. The display device according to claim 1, wherein when the front surface of said display panel is pressed, a light transmission characteristic of said display panel changes in the pressed portion.

9. The display device according to claim 8, wherein
said display panel is a liquid crystal panel in which a space between two substrates is filled with a liquid crystal material, and
when the front surface of said display panel is pressed, an orientation of liquid crystal molecules included in said liquid crystal material changes in the pressed portion.

10. The display device according to claim 1, wherein said display panel further comprises a light blocking unit that prevents external light from falling on said optical sensor.

11. The display device according to claim 1, wherein said light source is a backlight provided on a rear surface side of said display panel.

12. The display device according to claim 1, wherein said light source is a light-emitting element provided in said display panel.

13. The display device according to claim 1, wherein
said display panel is a self-emitting display panel, and
part of said display panel functions as said light source.

14. A display device having a plurality of optical sensors, comprising:
a display panel including a plurality of pixel circuits disposed two-dimensionally;
a plurality of optical sensors provided in said display panel;
a light source that emits light; and
an optical component provided outside said display panel for causing light emitted from said light source to fall on the optical sensor,
wherein when a detection object comes close to a front surface of said display panel, an optical path leading from said light source to said light sensor is blocked by said detection object, and an intensity of light detected by said optical sensor changes.

15. The display device according to claim 14, wherein
a first light reflecting unit that reflects light emitted from said light source in a direction parallel to said display panel and a second light reflecting unit that reflects light reflected by said first light reflecting unit toward said optical sensor are provided as said optical component such that said detection object can be introduced in an optical path between said first light reflecting unit and said second light reflecting unit.
